(19) United States
(12) Patent Application Publication
(10) Pub. No.: US 2005/0239486 A1
(43) Pub. Date: Oct. 27, 2005

(54) Methods and systems for controlling communications in an ad hoc communication network

(76) Inventors: Robert F. D'Avello, Lake Zurich, IL (US); Raymond L. Sokola, Long Grove, IL (US); Michael A. Newell, Williams Bay, WI (US); Scott B. Davis, Walworth, WI (US); Nick J. Grivas, Harvard, IL (US); James A. Van Bosch, Crystal Lake, IL (US)

Correspondence Address: MOTOROLA, INC., 1303 EAST ALGONQUIN ROAD, IL01/3RD, SCHAUMBURG, IL, 60196, US

(21) Appl. No.: 10/818,079

(22) Filed: Apr. 5, 2004

(51) Int. Cl. H04B 7/00

(52) U.S. Cl. 455/519; 455/507

(57) ABSTRACT

An improved system and procedure for controlling the audio broadcast to users participating in a group conversation. In one embodiment, a communications server employs arbitration logic to decide which of the user has priority to speak, and accordingly mixes only the audio data steams for those users for broadcast to all users. The server can send notification to the user interfaces to inform the users of their current priority status and to allow the users to request that their priority be increased, decreased, eliminated, or passed on for the benefit of another user. A user may also attempt at his user interface to affect the priority of identified other users by informing the arbitration logic of a rating for that user. Additionally, a systems administrator may also arbitrate user priorities, either at his discretion or in conjunction with suggestions provided by the arbitration logic. Finally, and regardless of system-assessed priorities, a user may at his user interface tailor the group conversation broadcast to him by either blocking reception of audio from certain users or by reducing their volume, or may tailor his outgoing audio transmission so they are blocked from being received by selected group conversation participants.

The present application is related to the following co-pending, commonly assigned patent applications, which were filed concurrently herewith and incorporated by reference in their entirety:

Ser. No. ______, entitled “Selectively Enabling Communications at a User Interface Using a Profile,” attorney docket TC00167, filed concurrently herewith.

Ser. No. ______, entitled “Method for Enabling Communications Dependent on User Location, User-Specified Location, or Orientation,” attorney docket TC00168, filed concurrently herewith.

Ser. No. ______, entitled “Methods for Sending Messages Based on the Location of Mobile Users in a Communication Network,” attorney docket TC00169, filed concurrently herewith.

Ser. No. ______, entitled “Methods for Displaying a Route Traveled by Mobile Users in a Communication Network,” attorney docket TC00170, filed concurrently herewith.

Ser. No. ______, entitled “Conversion of Calls from an Ad Hoc Communication Network,” attorney docket TC00172, filed concurrently herewith.

Ser. No. ______, entitled “Method for Entering a Personalized Communication Profile Into a Communication User Interface,” attorney docket TC00173, filed concurrently herewith.

Ser. No. ______, entitled “Methods for Controlling Processing of Inputs to a Vehicle Wireless Communication Interface,” attorney docket TC00175, filed concurrently herewith.

Ser. No. ______, entitled “Methods for Controlling Processing of Outputs to a Vehicle Wireless Communication Interface,” attorney docket TC00176, filed concurrently herewith.

Ser. No. ______, entitled “Programmable Foot Switch Useable in a Communications User Interface in a Vehicle,” attorney docket TC00177, filed concurrently herewith.

### FIELD OF THE INVENTION

This invention relates to systems and methods for controlling a group conversation, and more specifically to controlling the audio broadcast to users participating in the group conversation.

### BACKGROUND OF THE INVENTION

Communication systems, and especially wireless communication systems, are becoming more sophisticated, offering consumers improved functionality to communicate with one another. Such increased functionality has been particularly useful in the automotive arena, and vehicles are now being equipped with communication systems with improved audio (voice) wireless communication capabilities. For example, On Star™ is a well-known communication system currently employed in vehicles, and allows vehicle occupants to establish a telephone call with others (such as a service center) by activating a switch.

However, existing communications schemes lack flexibility to tailor group communications and other ad hoc communications. For instance, existing approaches depend heavily on establishing communication from one end of a communication (namely, a service center) and do not provide means for all parties to dynamically change the nature of the communications or the definition of the group. This lack of flexibility may prohibit group users from communicating as freely as they might wish.

There are issues, however, in establishing a more flexible communication scheme. For instance, many potential system users may be entitled to access a group conversation and to speak. As the number of participants in the group conversation grows, communications may become garbled as several speakers may all be trying to speak at once. This problem is illustrated in FIG. 1, which shows one way in which a server 24 may organize audio data in a push-to-talk communication system. All of the users can speak into microphones 68 to wirelessly provide audio data streams to the server 24 that could be mixed at an audio mixer 200. Regardless, the mixed audio data may be ultimately wirelessly transmitted back to the users for broadcast from speakers 78 in their vehicles 26. In this case, a given user will hear at least the voices of all other users superimposed through the speaker 78 in his vehicle 26, which may grow confusing as the number of potentially speaking other users increases.

In short, while a growing need exists to add group communications in a push-to-talk environment for vehicles, designs are needed to allow communications within the group to be organized to make the group conversation more manageable. This disclosure presents several different means for doing this.

It is, therefore, desirable to provide procedures for controlling a group conversation, and more specifically to controlling the audio broadcast to users participating in the group conversation.

### BRIEF DESCRIPTION OF THE DRAWINGS

FIG. 1 is diagram illustrating one system that could be used for mixing audio in an ad hoc communications system;

FIG. 2 is a block diagram of a wireless vehicular communications system;

FIG. 3 is a block diagram of a control system for a vehicular wireless communications system;

FIG. 4a is a diagram that illustrates a control system for a vehicular wireless communications system employing arbitration logic to broadcast only a subset of user audio data streams to group conversation participants;

FIG. 4b is a diagram that illustrates displays at user interfaces informing the users whether they are currently enabled to speak, and providing options to modify their current speaking priority;

FIG. 5 illustrates a display at a user interface which allows a user to pass speaking priority to another user through the use of an electronic token;

FIG. 6 illustrates a display at a user interface which allows a user to rate another currently speaking user to attempt to modify the other's priority during arbitration;

FIG. 7 illustrates a control system for a vehicular wireless communications system employing the use of a systems administrator to arbitrate the group conversation broadcast;

FIG. 8 illustrates a display at a user interface for allowing a user to modify the group conversation broadcast to him by blocking or reducing the volume of specified other group conversation participants;

FIG. 9a illustrates a control system for a vehicular wireless communications system useable with the display of FIG. 8 for modifying the broadcast of the group conversation at the server;

FIG. 9b illustrates a control system for a vehicular wireless communications system useable with the display of FIG. 8 for modifying the broadcast of the group conversation at the head unit coupled to the user interface; and

FIG. 10 illustrates a display at a user interface for allowing a user to block transmission of his audio data to a selected group conversation participant.

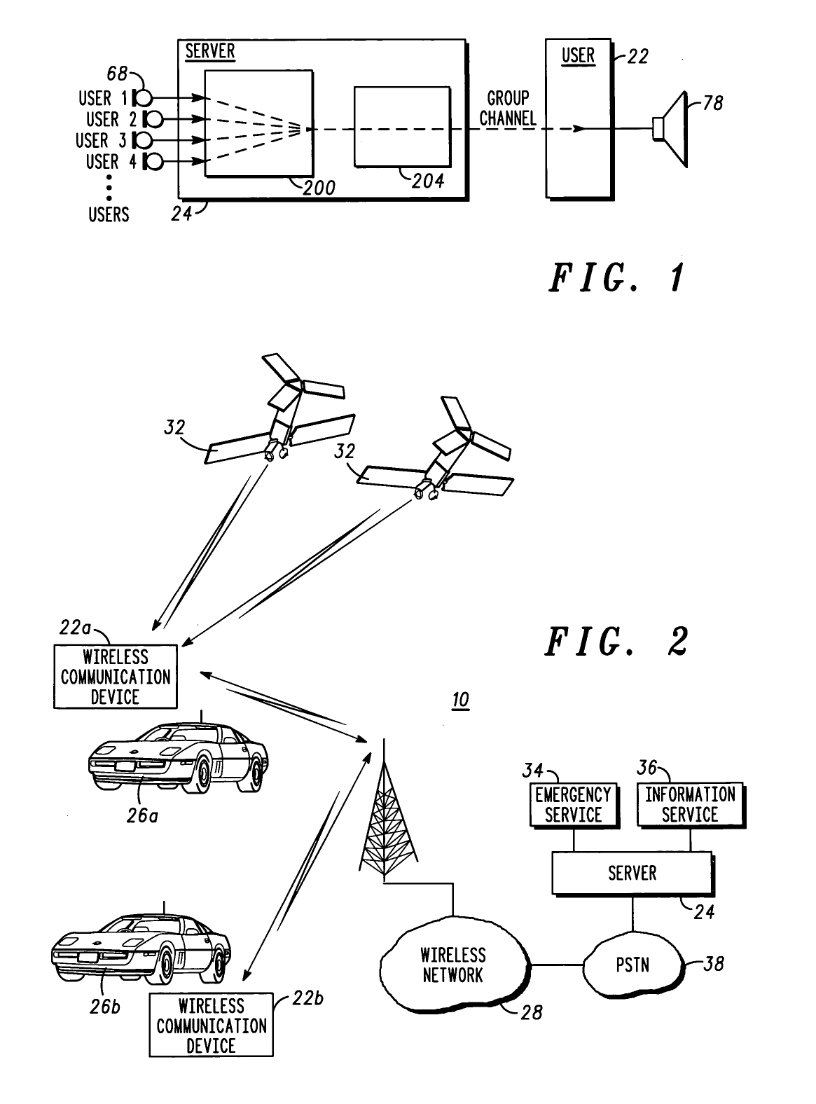

While the invention is susceptible to various modifications and alternative forms, specific embodiments have been shown by way of example in the drawings and will be described in detail herein. However, it should be understood that the invention is not intended to be limited to the particular forms disclosed. Rather, the invention is to cover all modifications, equivalents and alternatives falling within the spirit and scope of the invention as defined by the appended claims.

### DETAILED DESCRIPTION

What is described is a system and method for controlling the audio broadcast to users participating in a group conversation. In one embodiment, a communications server employs arbitration logic to decide which of the user has priority to speak, and accordingly mixes only the audio data steams for those users for broadcast to all users. The server can send notification to the user interfaces to inform the users of their current priority status and to allow the users to request that their priority be increased, decreased, eliminated, or passed on for the benefit of another user. A user may also attempt at his user interface to affect the priority of identified other users by informing the arbitration logic of a rating for that user. Additionally, a systems administrator may also arbitrate user priorities, either at his discretion or in conjunction with suggestions provided by the arbitration logic. Finally, and regardless of system-assessed priorities, a user may at his user interface tailor the group conversation broadcast to him by either blocking reception of audio from certain users or by reducing their volume, or may tailor his outgoing audio transmission so they are blocked from being received by selected group conversation participants.

Now, turning to the drawings, an example use of the present invention in an automotive setting will be explained. FIG. 2 shows an exemplary vehicle-based communication system 10. In this system, vehicles 26 are equipped with wireless communication devices 22, which will be described in further detail below. The communication device 22 is capable of sending and receiving voice (i.e., speech), data (such as textual or SMS data), and/or video. Thus, device 22 can wirelessly transmit or receive any of these types of information to a transceiver or base station coupled to a wireless network 28. Moreover, the wireless communication device may receive information from satellite communications. Ultimately, either network may be coupled to a public switched telephone network (PSTN) 38, the Internet, or other communication network on route to a server 24, which ultimately acts as the host for communications on the communication system 10 and may comprise a communications server. As well as administering communications between vehicles 26 wirelessly connected to the system, the server 24 can be part of a service center that provides other services to the vehicles 26, such as emergency services 34 or other information services 36 (such as restaurant services, directory assistance, etc.).

Further details of a typical wireless communications device 22 as employed in a vehicle 26 are shown in FIG. 3. In one embodiment, the device 22 is comprised of two main components: a head unit 50 and a Telematics control unit 40. The head unit 50 interfaces with or includes a user interface 51 with which the vehicle occupants interact when communicating with the system 10 or other vehicles coupled to the system. For example, a microphone 68 can be used to pick up a speaker's voice in the vehicle, and/or possibly to give commands to the head unit 50 if it is equipped with a voice recognition module 70. A keypad 72 may also be used to provide user input, with switches on the keypad 72 either being dedicated to particular functions (such as a push-to-talk switch, a switch to receive mapping information, etc.) or allowing for selection of options that the user interface provides.

The head unit 50 also comprises a navigation unit 62, which typically includes a Global Positioning Satellite (GPS) system for allowing the vehicle's location to be pinpointed, which is useful, for example, in associating the vehicle's location with mapping information the system provides. As is known, such a navigation unit communicates with GPS satellites (such as satellites 32) via a receiver. Also present is a positioning unit 66, which determines the direction in which the vehicle is pointing (north, north-east, etc.), and which is also useful for mapping a vehicle's progress along a route.

Ultimately, user and system inputs are processed by a controller 56 which executes processes in the head unit 50 accordingly, and provides outputs 54 to the occupants in the vehicle, such as through a speaker 78 or a display 79 coupled to the head unit 50. The speakers 78 employed can be the audio (radio) speakers normally present in the vehicle, of which there are typically four or more, although only one is shown for convenience. Moreover, in an alternative embodiment, the output 54 may include a text to speech converter to provide the option to hear an audible output of any text that is contained in a group communication channel that the user may be monitoring. This audio feature may be particular advantageous in the mobile environment where the user is operating a vehicle. Additionally, a memory 64 is coupled to the controller 56 to assist it in performing regulation of the inputs and outputs to the system. The controller 56 also communicates via a vehicle bus interface 58 to a vehicle bus 60, which carries communication information and other vehicle operational data throughout the vehicle.

The Telematics control unit 40 is similarly coupled to the vehicle bus 60, via a vehicle bus interface 48, and hence the head unit 50. The Telematics control unit 40 is essentially responsible for sending and receiving voice or data communications to and from the vehicle, i.e., wirelessly to and from the rest of the communications system 10. As such, it comprises a Telematics controller 46 to organize such communications, and a network access device (NAD) 42 which include a wireless transceiver. Although shown as separate components, one skilled in the art will recognize that aspects of the head unit 50 and the Telematics control unit 40, and components thereof, can be combined or swapped.

The wireless communications device 22 can provide a great deal of communicative flexibility within vehicle 26. For example, an occupant in a first vehicle 26a can call a second vehicle 26b to speak to its occupants either by pressing a switch on the keypad 72 of the head unit 50 or by simply speaking if the head unit is equipped with a voice recognition module 70. In one embodiment, the pressing of a switch or speaking into a voice recognition module initiates a cellular telephone call with a second vehicle 26b. In this case, users in either the first vehicle 26a or the second vehicle 26b can speak with each other without pressing any further switches. Moreover, the system may be configured to include a voice activated circuit such as a voice activated switch (VAS) or voice operated transmit (VOX). This would also provide for hands-free operation of the system by a user when communicating with other users.

In an alternative embodiment, the switch may be configured to establish a push-to-talk communication channel over a cellular network. Here, the controller 56 is configured to only allow audio by occupants in the first vehicle 26a through microphone 68 to be transmitted through the Telematics control unit 40 when a user in the first vehicle 26a is pressing down on the push-to-talk switch. The controller 56 is further configured to only allow audio received from the second vehicle 26b (or server 24) to be heard over speakers 78 when the operator of the first vehicle 26a is not pressing down on the switch. Alternatively, to avoid the need of holding down a switch to speak, the system may be configured to allow a user to push a button a first time to transmit audio and push the button a second time to receive audio.

In any event, the second vehicle 26b can, in like fashion, communicate back to the first vehicle 26a, with the speaker's voice being heard on speaker(s) 78 in the first vehicle. Or, an occupant in the first vehicle 26a can call the server 24 to receive services. Additionally, such a system 10 can have utility outside of the context of vehicle-based applications, and specifically can have utility with respect to other portable devices (cell phones, personal data assistants (PDAs), etc.). The use of the system in the context of vehicular communications is therefore merely exemplary.

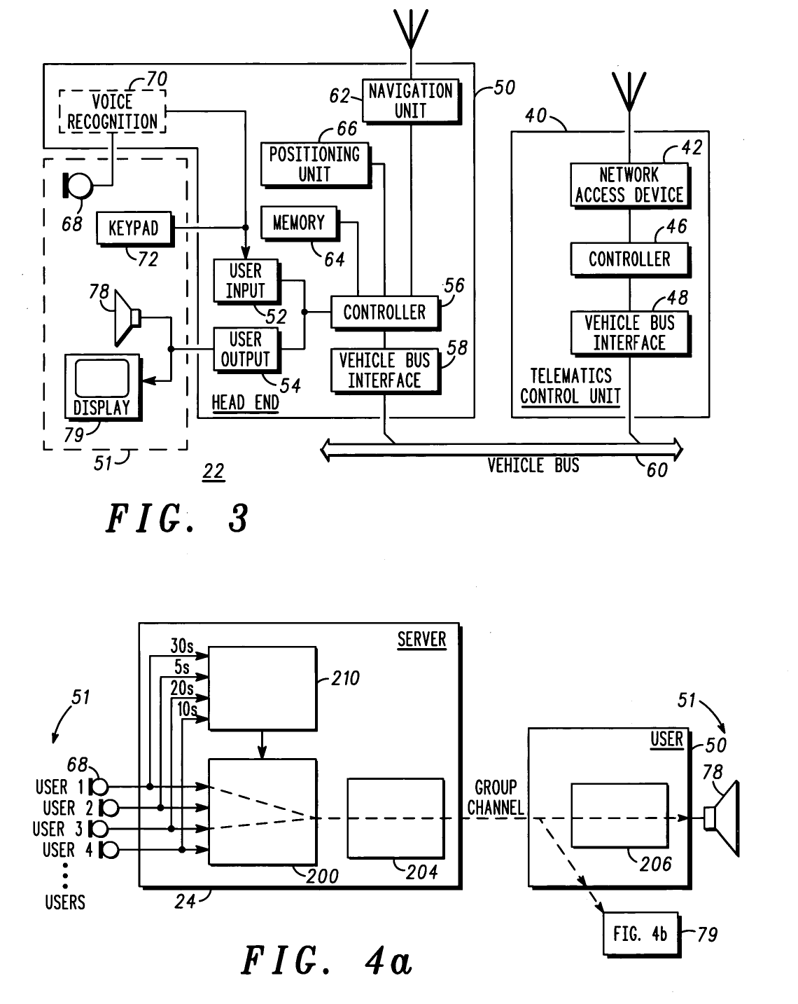

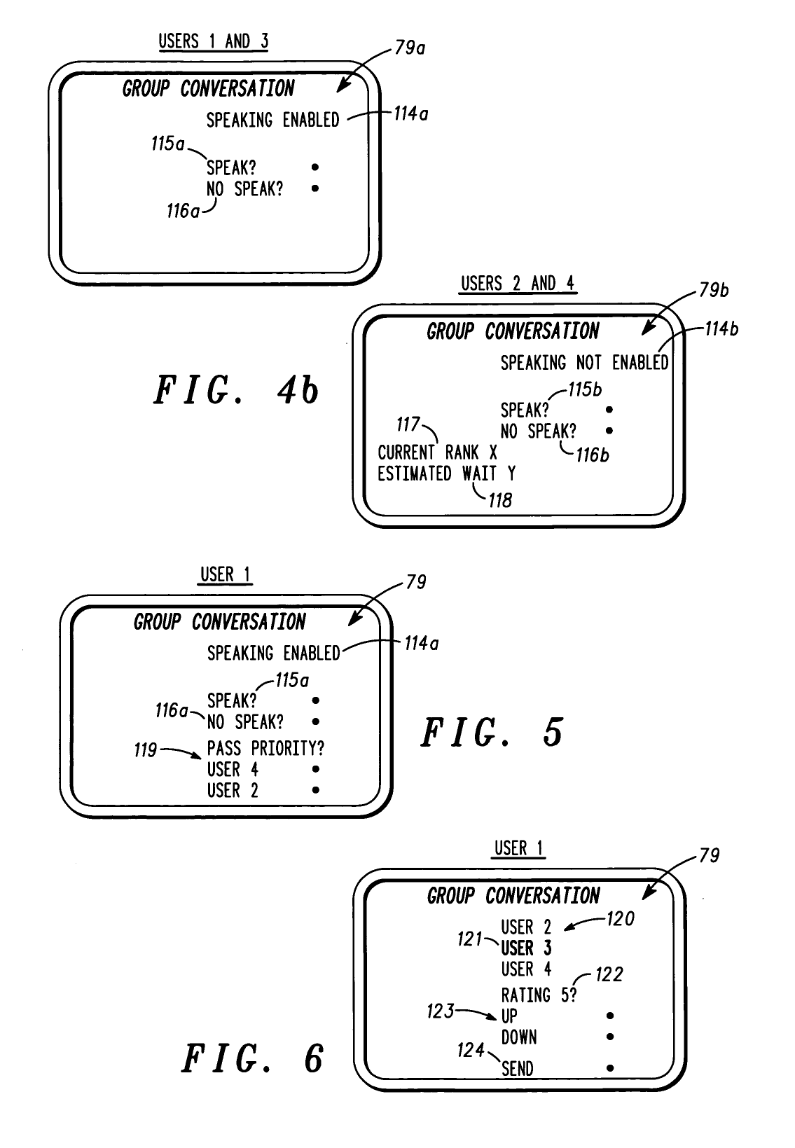

FIG. 4 illustrates one embodiment, in which the audio mixer 200 in the server 24 contains arbitration logic 210 to control the broadcast of audio to users participating in a group conversation. Essentially, arbitration logic 210 selects some subset of all incoming audio data streams from the users in a group conversation for mixing and subsequent broadcast to all users through a group channel receivable by the user interfaces of each user. Thus, arbitration logic 210 assesses user priority and controls the mixer so that not necessarily all of the incoming audio data streams from the users are mixed and broadcast. The effect is such that users participating in the group conversation may only hear a subset (or perhaps even just one) of all of the group conversation participants, thereby better controlling the group conversation and making the conversation less confusing to its participants.

In a preferred embodiment for the system 10, incoming audio data streams are accompanied by the use of user IDs. In this regard, as audio data streams are broadcast from the Telematics control units 40 of the various users, their head units 50 automatically include with the data stream an ID code to the server 24 so that the server 24 and/or the arbitration logic 210 can appropriately manage the group call. Many different styles of user ID codes can be used by the system, such as a phone number, a “handle,” a Vehicle Identification number (VIN), an Electronic Serial Number (ESN), an International Mobile Subscriber Number (IMSI), or a Mobile Subscriber International ISDN Number (MSISDN), all of which are referred to herein as “user IDs” for convenience. As one skilled in the art understands, a user's user ID may be included in a data header which accompanies the transfer of data from the user, which may be predictably formatted so that it is understandable by the server 24.

In one embodiment, the arbitration logic 210 keeps track of how long it has been since particular users have spoken in the group conversation, and preferentially affords speaking priority only to those users who spoke the longest time ago. For example, suppose the arbitration logic 210 will only permit two users' audio data to be mixed and broadcast along a group channel at one time in an effort to keep the group conversation broadcast manageable. The arbitration logic 210 is fed the audio data streams for each of the users. From these streams, the arbitration logic can determine and store, based on an assessment of the user IDs in the streams and their time of arrival, how long it has been since a particular user last spoke on the system. Thus, suppose it has been 30 seconds since user 1 last spoke; 5 second since user 2 has spoken; 20 seconds since user 3 has spoken; and 10 second since user 4 has spoken. Pursuant to the algorithm in the arbitration logic 210, that logic will determine that user 1 and 3 spoke longest ago on the system and therefore that they have priority and will be enabled to speak and have their voices be broadcast. Accordingly, the arbitration logic 210 sends a control signal to the mixer 200 to gate the audio streams for user 1 and 3 into the mixer, and to gate streams for user 2 and 4 off so that they are not mixed. Alternatively, the arbitration logic 210 may send a control signal to the mixer 200 to adjust the volumes of the audio streams for particular users based on speaking priorities.

Feedback concerning the arbitration process can also be provided back to the users' interfaces 51. As illustrated in FIG. 4b, the displays 79 of the user interfaces 51 can receive information from the arbitration logic 210 embedded in the header of group conversation broadcast indicative of the user's status, and specifically can contain the user ID that are or are not enabled to speak at any given time. For example, display 79b of users 2 and 4 displays that those users are not enabled to speak at the moment (114b), whereas display 79a informs user 1 and 3 that they can speak (114a) by pressing the push-to-talk buttons on their user interfaces (not shown).

The system users can also provide input to the arbitration unit 210 to assist it in arbitrating and to otherwise help it to make logical arbitrations decisions based on particular user's preferences. Thus, and regardless of their current status as enabled or non-enabled speakers, the users' displays 79 can include a touch screen with buttons to send to the server 24 and arbitration logic 210 their desire to speak on the group call (buttons 115a, b) or not to speak in the near future (buttons 116a, b). This aspect recognizes certain users granted priority may merely want to listen for substantial periods of time, while other speakers who have not granted priority may need to speak. Recognizing this, users can toggle buttons 115a, b on their user interfaces 51 to send a request to the arbitrator logic 210 to request priority or consideration in the arbitration process, or can toggle buttons 116a, 6 to inform the arbitrator logic to not consider them at present and to disable their priority.

For example, suppose users 1 and 3 have been afforded priority as shown, but that user 1 does not anticipate speaking in the near future. Suppose further that user 2 wishes to speak despite that fact that he is currently not enabled by the arbitration logic, and that users 3 and 4 are unconcerned about their priority. User 1 could press his button 116a, and user 2 can press his button 115b. When these instructions are received by the arbitration unit, the arbitration unit can disable user 1's priority, and essentially ignore user 1 in its arbitration process for so long as user 1's button 116a is toggled. Accordingly, the arbitration logic 210 reconsider priority, which would otherwise result in users 3 (20 seconds) and 4 (10 seconds) having priority over user 2 (5 seconds), again assuming that the arbitration logic only permits a maximum of two audio data streams to be mixed in this simple example. However, the arbitration logic 210 recognizes user 2's request to speak (button 115b), and accordingly could grant priority to that user, perhaps by first verifying that no other user has earlier requested priority ion this manner and has been waiting longer for such priority. Thus, in the end, and based on the previously granted priority and the status of the buttons 115, 116 pressed by the users, the arbitration logic could enable user 2 (the priority requester) and user 3 (the otherwise longest-waiting user in accordance with the default priority rules).

To further assist users in understanding the status that has been accorded to them by the arbitration logic 210, the arbitration logic can compute a user's current priority rank (117) and estimated time to become an enabled speaker (118). Although such information is potentially useful to all users, it is particularly useful to currently non-enabled users, and thus is so illustrated in FIG. 4b. Priority rank 117 can be a number indicating the non-enabled user's “place in line.” Thus, pursuant to the example illustrated in FIG. 4a, whereby user 1 and 3 are currently enabled, user 4's rank would be a “1,” while user 2's rank would be a “2.” Estimated time 117 can be computed by the arbitration logic using statistical analysis, perhaps based upon the number of users currently involved in the group conversation, historical data concerning the call, etc. As the users press various buttons to indicate priority preferences, these fields 117, 118 can be updated, and/or can disappear once a user becomes enabled. As noted earlier, such user-specified command can be wirelessly transmitted to the server 24 as header data.

In a preferred embodiment, buttons 115, 116 are different from the push-to-talk buttons that the user actually uses when speaking (not shown for convenience). Thus, the user could press one of the buttons 115, 116, then wait to be notified that he is enabled (114a), and then can press his push-to-talk button to speak. However, this need not be the case. For example, request button 115a, b can also simultaneously function as the push-to-talk button in some embodiments, in a sense guaranteeing priority to a particular user so long as the arbitration logic will allow it.

Of course, the foregoing example provides only a simple illustration of how the arbitration logic 210 can function, and how the user can attempt to modify the operation of that logic. Many other arbitration and priorities schemes are possible. For example, priority can also be adjusted on the extent to which a given user has spoken during a conversation, with higher-frequency participants being granted higher priorities than lower-frequency participants, on the theory that such frequently speaking participants probably require such priority. On the contrary, lower-frequency participants could be accorded higher priority on the theory that it is fair to let them have their turn should they so desire. In short, the actual arbitration scheme employed by logic 210 can be adjusted to suit user preferences.

In an alternative embodiment, a given user, instead of merely requesting or defeating his own priority, can pass priority on to other users. Such an embodiment can be effectuated by the use of an electronic token, as is illustrated in FIG. 5, which illustrates the display 79 in the user interface 51 of a currently enabled user (e.g., user 1). In one embodiment, the server 24 broadcasts the results of the arbitration process to those users who are currently enabled, and specifically the user IDs for those others user that presently do not have priority (i.e., users 4 and 2). As shown, these user IDs can be displayed on user 1's display 79 in conjunction with touch screen buttons 119. Using these buttons 119, user 1 can pass his priority to one of these other currently non-enabled users. The displayed non-enabled users are preferably listed by priority rank as discussed above so that user 1 can understand who has been waiting the longest and therefore who might be most deserving of receiving user 1's priority. When a button 119 is pressed, the user IDs for the token-passing user (user 1) and the token-receiving user (user 4) are transmitted back to the server 24 and the arbitration logic 210 along with an instruction to the arbitration logic 210 to pass priority, which instruction may be thought of as an electronic token. Upon receipt of this instruction (token), the arbitration logic 210 can verify that user 1 in fact has priority to delegate, and can take appropriate action either by adjusting user 4's priority upward or by granting user 4 immediate priority, depending on the priority algorithm that the arbitration logic 210 is running.

In another embodiment, instead of passing priority through the use of electronic tokens, the users can attempt to affect the priority to be granted to other users through a rating system, as illustrated in the user interface display 79 of FIG. 6. In this embodiment, the display 79 lists (120) the user IDs for the various users connected to the group conversation, or least displays the user IDs for the users who are currently speaking, determinations which can be made through the head unit's 50 assessment of the header in the group channel audio broadcast. As shown, the currently speaking user's ID is highlighted (121), and that highlighted user can be rated (122) using up/down rating buttons 123 as shown. In such a scheme, the helpfulness, politeness, etc. of the users in the context of the group conversation can be rated on a scale from 0 to 10, with 0 denoting an unreasonable, obnoxious, or abusive conversation participant, and 10 denoting a polite and insightful participant deserving of system priority. A default rating of 5 can be used. As various users speak, the current rating established by the user at that interface (e.g., user 1) is retrieved from memory 64 and displayed accordingly. At that time, the user can adjust the speaking user's rating using the up/down buttons, at which time, such rating can be transmitted from the user interface back to the server 24 and arbitration logic 210, or alternatively, the rating can be sent by pressing “send” button 124. Of course, there are many different ways to rate system users, to display the same, and to send the rating to the server, and thus FIG. 6 is merely exemplary.

Regardless, once the ratings are received by the arbitration logic 210, the arbitration logic can use such ratings to assist it in its arbitration decisions and in the adjustment of system priority. For example, ratings received for each of the user could be averaged and used as a weighting factor to adjust system priority; in a simple example, should one user have a rating 3 times that of another user, the arbitration logic could strive to grant priority three times more frequently to that higher-rated user. Or ratings could be used as cut-off values; if a certain user's average rating falls below some threshold (e.g., 2), that user may be forever barred from receiving priority and being enabled to speak, whereas highly rated users (e.g., 8 or above) may preferentially always receive priority whenever possible in accordance with the default priority algorithm. Alternatively, low rating, or a prolonged history of low rating, may be used by the server 24 to simply disconnect the low-rated user from the group conversation altogether, such that that user will not even be permitted to listen to the conversation let alone speak. Again, processing and priority adjustment using user ratings could be affected in several different ways.

Although FIG. 6 contemplates the convenience of rating a particular user while he is speaking, it should be understood that participants in the group conversation can be subject to ratings even when they are not speaking.

Alternatively, a user's ranking can be used to block or reduce the volume at which the low-ranked user's voice data is heard by other group conversation participants. Further details concerning affecting such blocking and/or volume reduction are discussed further below in conjunction with a description of alternative embodiments.

In another embodiment shown in FIG. 7, the arbitration logic 210 may be replaced by, or controlled by, a server administrator, i.e., a person whose job it is to keep track of the various group conversation users, their priorities, and requests, and to control the audio mixer 200 to allow only certain subsets of users' voices to be broadcast to other users. The server administrator preferably uses a computer terminal 220 connected to the arbitration logic 210 in the server 24. In one embodiment, the computer terminal 220 displays to the system administrator a list of users connected to the group call, user requests, user ratings, user rankings, the results of any priority algorithms that might be running in the arbitration logic, etc.—i.e., basically all data that the arbitration logic 210 received, processed, and generated in earlier embodiments. On the basis of this data, the system administrator can let the system run according to its default priority rules, or if necessary can override such priorities to improve the fluidity of the group conversation. If necessary, the system administrator's terminal 220 can contain a microphone 222 to allow the administrator to speak to the users to inform them of system details or anything else the users might need to know during a group conversation. While it is preferred that the system administration terminal 220 work in conjunction with default priority rules as established by the arbitration logic 210, and to merely modify those settings when appropriate, the system administrator may instead completely control and establish priority using his own judgment and sense of fairness.

In the foregoing embodiments, communications in a group conversation on a wireless network are organized by either the system (i.e., arbitration logic 210 or administrator 220) or the user (through the use of electronic token, ratings, etc.). However, in these embodiments, the server 24 ultimately broadcast the same mixed audio signals to the various users participating in the group conversation. While these schemes certainly provide some degree of control and organization to the group conversation, certain users may be interested to individually tailor the broadcast that they hear.

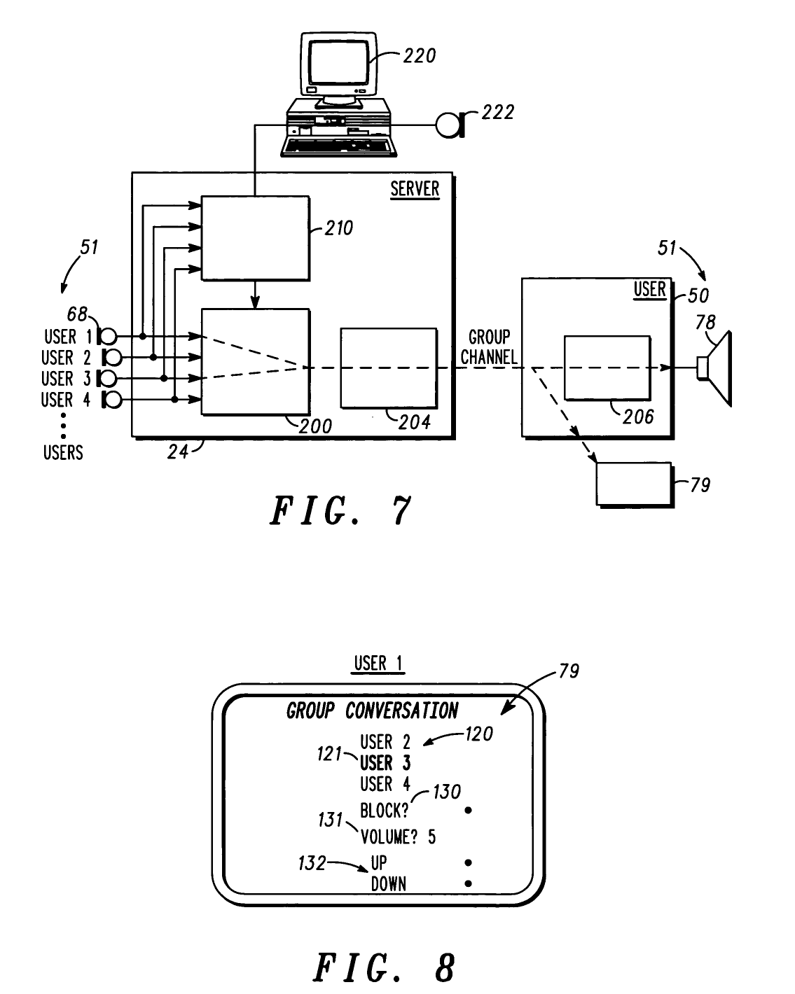

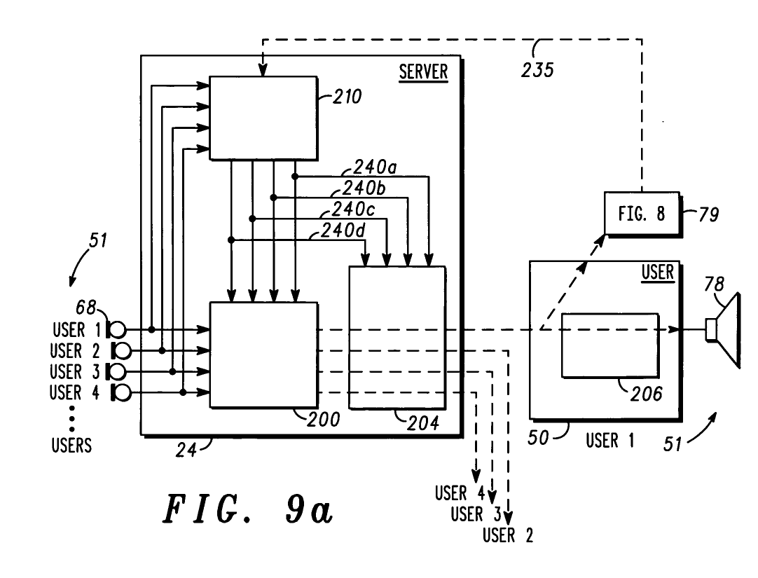

FIG. 8 shows a display 79 of a user's user interface 51 which allows for such tailoring. As before, displayed is a list of users participating in the group conversation, and again the presently speaking person is highlighted (121) (e.g., user 3). In conjunction with such highlighting, the user at the user interface (e.g., user 1) can select how the audio for that currently speaking user (user 3) will be treated at his user interface. For example, suppose user 1 finds user 3's participation in the group conversation unhelpful or abusive. User 1 can choose to block (130) audio broadcasts from user 3, or can choose to otherwise modify (e.g., diminish) (131) the volume of broadcasts from that user so that his speech can still be heard but without prevalence. Volume adjustment, like the rating scheme disclosed earlier, can be quantized with a number and subject to adjustment by up/down buttons 132. (Alternatively, volume adjustment can also indicate a rating back to the system, or vice versa).

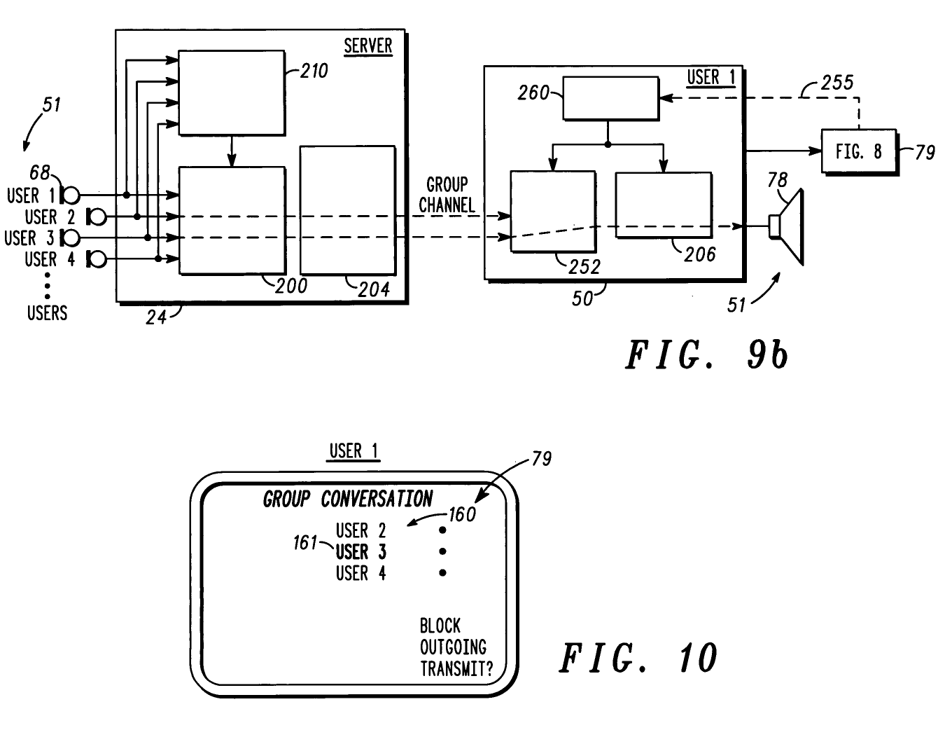

Affecting such user preferences with respect to the broadcast that user hears can be effected either at the server 24 or at the user's head unit 50, as illustrated in FIGS. 9a and 9b. FIG. 9a illustrates an embodiment in which user preferences may be handled at the server 24. Specifically, when a user (e.g., user 1) selects to block (130) or reduce the volume of (131) a particular user (see FIG. 8), user 1's user interface 51 ultimately wirelessly transmits these parameters along wireless link 235 back to the server 24, and more specifically to the arbitration unit 210. The arbitration unit 210 interprets these parameters to ultimately devise an individualized broadcast for user 1, which contain user 1's user ID in the header to denote the same. Similarly, other individualized broadcasts are formulated for the other users as shown, each keyed with particular users' user IDs. Upon receipt of the modification parameters (over wireless link 235) from user 1, the arbitration logic 210 can take appropriate action to generate the individualized broadcast for that user. This may be accomplished by the arbitration logic generating specific control signals 240a-d for the audio mixer 200 and/or audio processing unit 204. For example, suppose user 1 presses button 130 to block broadcasts from user 2 as part of the group conversation he receives. Arbitration logic 210 can generate a specific control signal 240a for user 1, in which all audio data streams from the various users are mixed in accordance with the arbitration rules, but excluding user 2 from the mix. Likewise, if mere volume reduction of user 2 is desired, that same control signal 240a can adjust the volume of user 2's audio input prior to or during mixing to provide a broadcast to user 1 with diminished user 2 volume. Moreover, filtering and other audio adjustments may be accomplished by audio processing units, which may be located within the server (204) or within the head units 50 (206) coupled to the user interfaces 51.

FIG. 9b illustrates an embodiment in which user preferences may be handled at the various head units 50 for the various users. In this embodiment, audio mixing is performed at an audio mixer 252 within the head unit coupled to each user's user interface 51. Therefore, the audio mixer 200 in the server 24 is replaced with a gate 250, which allows certain unmixed audio data streams, i.e., those chosen by arbitration logic 210 as discussed earlier, to be broadcast to all users along the group wireless channel. Although sent along a single channel, the multiple audio data streams can be interleaved and individually reconfigured at the head units 50 in accordance with user ID header information, as one skilled in the art understands; however each data stream is shown individually in FIG. 9b for convenience. Alternatively, the individual audio data streams may be sent as sub-channels within the group channel to the same effect.

In response to blocking or volume reduction commands 252, a mixer controller 260 identifies each stream and processes it accordingly. The mixer controller 260 may comprise or be coupled to the controller 56 already resident in the head unit 50. For example, suppose the audio streams for user 2 and 3 have been chosen for broadcast by the arbitration logic 210, but that user 1 wants user 2's stream to be blocked. User 1 selects the appropriate button 130 (FIG. 8) to block user 2, thus sending a blocking command via signal 255 to the mixer controller 260. The mixer controller 260 will then identify user 2's data stream and prevent it from being mixed and broadcast to user 1 through his speakers 78. Similarly, were volume reduction selected, the stream for user 2 could be reduced prior to mixing or reduced appropriately during mixing.

In another embodiment, a particular user, instead of wishing to block an audio data stream from a particular user, may wish to block his own audio data stream so that it cannot be heard by a particular other user but can be heard by all other group conversation participants. Such a feature can be useful, for example, if a given user wishes to comment (perhaps negatively) on a particular group conversation participant, but does not want that participant to hear the comment. In this regard, the system disclosed in FIG. 9a, which tailors a specific broadcast stream for each user, can be used. For example, and referring to FIG. 10, a user (e.g., user 1) may wish to make a comment about user 3, and therefore may wish to block broadcast of his comment to user 3, a so-called outgoing block. Accordingly, that user (user 3) can be selected on user 1's display 79 of his user interface 51 using touch screen buttons 160. The outgoing blocked user can thereafter be highlighted on user 1's display 79 as shown (161), so that user I will not forget about this status, and can later unblock that user if need be. (Unblocking, while not shown, would involve depressing an unblock button or some like feature).

Thereafter, while user 3 is blocked, the arbitration logic 210 is informed by wirelessly transmitting this fact via wireless link 235 (FIG. 9a). In response, the arbitration logic 210 formulates a control signal (e.g., 240c) used to control user 3's broadcast, and such control signal will not mix user 1's audio data stream into that broadcast, even if this means overriding the broadcasting decisions other made by the arbitration logic 210 through application of default rules.

While preferable, it should be noted that the user-tailoring schemes of FIGS. 8-10 need not be accompanied by system arbitration. In other words, even absent arbitration, the users may simply tailor which users they hear and the respective volumes at which they hear them by making the sorts of selections shown in FIG. 8. Such user-specified “arbitration” may be all that is needed (particularly in a relatively small group conversation) to make a group conversation manageable to its participants.

While largely described with respect to improving communications within vehicles, one skilled in the art will understand that many of the concepts disclosed herein could have applicability to other portable communicative user interfaces not contained within vehicles, such as cell phones, personal data assistants (PDAs), portable computers, etc., what can be referred to collectively as portable communication devices.

Although many examples of displays 79 in user interfaces 51 and their respective content and options have been separately illustrated, one skilled in the art with the benefit of this disclosure will understand that in an actual commercial embodiment of a display for a user interface, the content of these various displays may be consolidated into a single display, or each display made accessible through a menu structure or like organizational means.

Although several discrete embodiments are disclosed, one skilled in the art will appreciate that the embodiments can be combined with one another, and that the use of one is not necessarily exclusive of the use of other embodiments. Moreover, the above description of the present invention is intended to be exemplary only and is not intended to limit the scope of any patent issuing from this application. The present invention is intended to be limited only by the scope and spirit of the following claims.

1. A method for controlling a group voice conversation on a communication network, comprising:
allowing a plurality of users to join the group voice conversation via user interfaces;
potentially receiving at the communication network voice data from the joined users; and
broadcasting to all joined users mixed voice data selected from only a subset of the joined users.

2. The method of claim 1, wherein the subset is determined in accordance with an arbitration process.

3. The method of claim 2, wherein the arbitration process affords priority to the subset on the basis of which joined users last spoke.

4. The method of claim 1, wherein the joined users can modify the arbitration process using their user interfaces.

5. The method of claim 4, wherein the modification comprises a user defeating or requesting his own priority.

6. The method of claim 4, wherein the modification comprises one user in the subset passing priority to another joined users.

7. The method of claim 4, wherein the modification comprises assigning a joined user a rating.

8. The method of claim 2, wherein data indicative of the arbitration process are sent to the user interfaces of at least some of the joined users.

9. The method of claim 8, wherein the data comprises an indication whether a particular user in the subset or not.

10. The method of claim 8, wherein the data comprises an indication of a joined user's current priority level.

11. The method of claim 2, wherein the arbitration process is controlled at least in part by a system administrator in communication with the communication network.

12. A method for allowing a first user to control a group voice conversation on a communication network from a first user interface, comprising:
allowing a plurality of other users to join the group voice conversation via user interfaces;
receiving at the communication network voice data and user ID from the other users and broadcasting the same to the other users' user interfaces; and
permitting the first user to select at least one of the other user's user ID on the first user interface to impair the first user's ability to hear that other user's voice data through his user interface.

13. The method of claim 12, wherein impairment of the first user's ability to hear comprises blocking the other user's voice data.

14. The method of claim 12, wherein impairment of the first user's ability to hear comprises reducing the volume of the other user's voice data.

15. The method of claim 12, wherein impairment of the first user's ability to hear is effected at the communication network.

16. The method of claim 2, wherein impairment of the first user's ability to hear is effected at a control system coupled to the first user's user interface.

17. The method of claim 2, wherein the other user's user ID is displayed on the first user's user interface prior to the first user's selection of that data.

18. A method for allowing a first user to control a group voice conversation on a communication network from a first user interface, comprising:
allowing a plurality of other users to join the group voice conversation via user interfaces;
receiving at the communication network voice data and user ID from the other users and broadcasting the same to the other users' user interfaces; and
permitting the first user to select at least one of the other user's user ID on the first user interface to impair the other user's ability to hear the first user's voice data through his user interface.

19. The method of claim 18, wherein impairment of the first user's ability to hear comprises blocking the other user's voice data.

20. The method of claim 18, wherein impairment of the first user's ability to hear comprises reducing the volume of the other user's voice data.

21. The method of claim 18, wherein impairment of the first user's ability to hear is effected at the communication network.

22. The method of claim 18, wherein impairment of the first user's ability to hear is effected at a control system coupled to the first user's user interface.

23. The method of claim 18, wherein the other user's user ID is displayed on the first user's user interface prior to the first user's selection of that data.

24. A method for allowing a first user to control a group voice conversation on a communication network from a first user interface, comprising:
allowing a plurality of other users to join the group voice conversation via user interfaces;
receiving at the communication network voice data and user ID from the other users and broadcasting the same to the other users' user interfaces; and
permitting the first user to select at least one of the other user's user ID on the first user interface to rate the other's user's participation in the group conversation.

25. The method of claim 24, further comprising having the communication network using the rating to selectively disconnect the other user from the group voice conversation.

26. The method of claim 24, wherein the rating affects the other user's priority to speak during the voice conversation.

27. The method of claim 24, wherein the rating affects the volume at which the other user's voice data is broadcast to the other users in the group conversation.

28. The method of claim 24, wherein the rating blocks the other user's voice data from being broadcast to the other users in the group conversation.

29. The method of claim 24, wherein the other user's user ID is displayed on the first user's user interface prior to the first user's selection of that data to rate the other user's participation.
